(19) United States
(12) Patent Application Publication
(10) Pub. No.: US 2025/0293317 A1
(43) Pub. Date: Sep. 18, 2025

(54) RECHARGEABLE AQUEOUS MG BATTERY WITH A SOLID-STATE POLYMERELECTROLYTE

(71) Applicant: Versitech Limited, Hong Kong (CN)

(72) Inventors: Kee Wah LEONG, Hong Kong (CN); Wending PAN, Hong Kong (CN); Yiu Cheong LEUNG, Hong Kong (CN)

(73) Assignee: Versitech Limited, Hong Kong (CN)

(21) Appl. No.: 18/862,943

(22) PCT Filed: May 18, 2023
(86) PCT No.: PCT/CN2023/094935

§ 371 Date: Nov. 4, 2024

Related U.S. Application Data
(60) Provisional application No. 63/354,666, filed on Jun. 22, 2022.

(51) Int. Cl. H01M 10/26; H01M 4/02; H01M 4/46

(52) U.S. Cl. CPC H01M 10/26; H01M 4/466; H01M 2004/027

(57) ABSTRACT

A rechargeable aqueous Mg battery is composed of a Mg metal anode, a solid-state aqueous polymer-based electrolyte, and an intercalation-type Prussian blue analogue cathode for ion storage. During battery operation, the Mg anode undergoes dissolution and deposition, while Mg ions in the electrolyte are inserted and extracted from the cathode lattice, thereby releasing energy during discharge and storing energy during charge.

### CROSS-REFERENCE TO RELATED PATENT APPLICATIONS

This application is a U.S. National Stage Application under 35 U.S.C. § 371 of International Patent Application No. PCT/CN2023/094935, filed May 18, 2023, and claims the benefit of priority under 35 U.S.C. Section 119 (e) of U.S. Application No. 63/354,666, filed Jun. 22, 2022, all of which are incorporated herein by reference in their entireties. The International Application was published in English on Dec. 28, 2023 as International Publication No. WO 2023/246387 A1.

### FIELD OF THE INVENTION

The present invention relates to rechargeable batteries and, more particularly, to rechargeable Mg batteries.

### BACKGROUND OF THE INVENTION

Conventional Li-ion battery technology poses safety, cost, and environmental concerns due to its material scarcity and toxicity. Mg is the 5th most earth-abundant metal that possesses low toxicity and high biodegradability. Thus, rechargeable Mg batteries have been developed that are safer, cost less and are greener, i.e., better for the environment, than Li-ion batteries.

Within the field of rechargeable Mg batteries, the major problem is the strong passivation tendency of Mg, which restricts the battery reversibility in aqueous solutions. Thus, existing Mg batteries employ nonaqueous organic electrolytes. However, these organic electrolytes are often costly, unstable, and may even require moisture-free and oxygen-free conditions that are rather impractical.

US Application Publication 2008/0182176 discloses a Mg metal battery technology using a non-aqueous electrolyte, composed of a Mg—Al salt dissolved in ether solvents. China Patent CN110265712 also discloses a Mg metal battery technology using a non-aqueous electrolyte, composed of a complex Mg-based salt and Li-based salt dissolved in organic solvents. An article by Wang et. al., entitled “Porous polymer electrolytes for long-cycle stable quasi-solid-state magnesium batteries” (DOI: 10.1016/j.jechem.2020.12.004) discloses Mg metal battery technology using a quasi-solid-state electrolyte, synthesized by immersing porous PVDF-HFP membranes in an organic Mg—Al solution.

US Application Publication 2015/0229000 discloses Mg battery technology using an all-solid-state electrolyte composed of Mg(BH₄)₂, MgO nanoparticles, and polyethylene oxide. An article by Xu et. al., entitled “Solid Electrolyte Interface Regulated by Solvent-in-Water Electrolyte Enables High-Voltage and Stable Aqueous Mg—MnO₂ Batteries,” (DOI: 10.1002/aenm.202103352) discloses a hybrid Mg/MnO₂ battery technology using an aqueous solid-state electrolyte with Mg-based and Mn-based salts in a polymer. This Mn2+/Mn02 battery mechanism is based on Mn ion storage.

It would be of great benefit to have an Mg battery with an aqueous based, as opposed to non-aqueous, quasi-solid-state electrolyte made with a common salt, which can operate in an ambient environment and is stable and low cost.

### SUMMARY OF THE INVENTION

The present invention solves the problem of prior art Mg. batteries by providing a reversible aqueous Mg battery that can be operated in ambient air. This is achieved by using a solid-state electrolyte in the form of an economical salt, MgCl₂, and a polymer material.

The invention is a rechargeable aqueous Mg battery composed of a Mg metal anode, a solid-state aqueous polymer-based electrolyte, and an intercalation-type Prussian blue analogue cathode for ion storage. The material choices available for the present invention make it a lower-cost, safer, and cleaner alternative to conventional battery technologies.

The invention makes use of aqueous Mg battery chemistry by suppressing Mg passivation using a polymer-strengthened electrolyte with a simple salt MgCl₂. Compared to the expensive complex salts and volatile solvents used in organic electrolytes, the aqueous solid-state electrolyte in this invention is more cost-effective and stable. Further, the battery can be operated in ambient air, rather than under controlled environments

In summary, Mg metal is used as the anode of the battery instead of intercalation-type host materials used in the prior art. An aqueous electrolyte is used instead of an organic electrolyte and the addition of polymer in the aqueous MgCl₂ electrolyte facilitates Mg reversibility.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1A is a schematic illustration of the battery mechanism with a Mg metal anode, a MgCl₂-PEO electrolyte, and a CuHCF cathode according to the present invention;

FIG. 1B is an exploded view of the battery structure according to the present invention with an inset photo of the assembled cell;

FIG. 1C illustrates galvanostatic discharge-charge curves of the battery of the present invention at various current densities;

FIG. 1D is a graph of specific capacity and Coulombic efficiency of the battery of the present invention at various current densities;

FIG. 1E is a graph of long-term battery cycling stability of the battery of the present invention at 1 A g⁻¹;

FIG. 1F illustrates a performance comparison with other rechargeable Mg batteries, including non-aqueous Mg metal batteries (NAMMB) and aqueous Mg-ion batteries (AMIB);

FIG. 2A is a Fourier-transform infrared spectroscopy (FTIR) spectra of MgCl₂-WIS and MgCl₂-PEO electrolytes;

FIG. 2B illustrates the electrochemical stability window of MgCl₂-WIS and MgCl₂-PEO electrolytes;

FIG. 2C is a cyclic voltammetry (CV) curve of the Mg/CuHCF full cell in MgCl₂-PEO at a scan rate of 10 mV/s;

FIG. 2D shows half-cell CV curves of CuHCF cathodes covered by AEM and CEM;

FIG. 2E shows a bar chart comparison of the atomic ratios of Mg and Cl, normalized with respect to Fe, in CuHCF at different states of charge, obtained by SEM-EDS (left panel), and representative galvanostatic charge-discharge curve of the Mg/CuHCF full battery, illustrating the corresponding states of charge where the CuHCF samples are obtained (right panel);

FIG. 2F shows photos of TEM-EDS mapping of a fully charged sample of CuHCF in MgCl₂-PEO;

FIG. 3A shows galvanostatic cycling curves of the battery of the present invention at room temperature and at −22° C., with a photo of the measurement device in the insert;

FIG. 3B shows long-term battery cycling stability at −22° C. at 0.5 A g⁻¹;

FIG. 3C shows a setup including a LED bulb lit up by the battery of the present invention under a high pressure of 4 Mpa; and

FIG. 3D shows images of the flammable organic Li-ion electrolyte and non-flammable MgCl₂-PEO electrolyte.

### DETAILED DESCRIPTION OF THE INVENTION

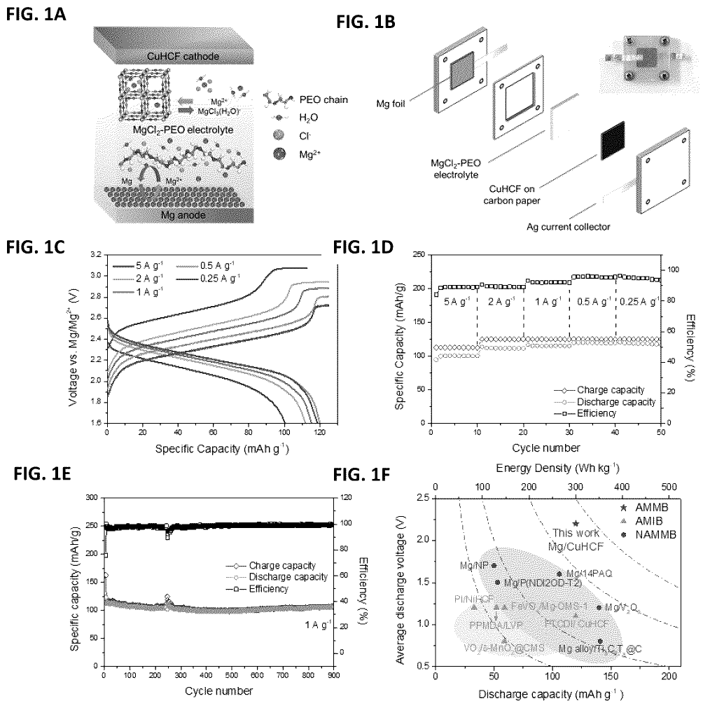

A schematic design of an aqueous Mg metal battery (AMMB) is illustrated in FIG. 1A. The battery components include a Mg anode, a solid-state MgCl₂-polyethylene oxide (PEO) electrolyte, and a copper hexacyanoferrate (CuHCF) cathode with a chemical formula of Cu₂[Fe(CN)₆]. During battery cycling, the Mg anode undergoes metal stripping and plating, while the CuHCF cathode provides storage sites for ion insertion and extraction. With a cubic lattice structure, a Prussian blue analogue CuHCF cathode provides abundant sites for ion storage. In this embodiment, the MgCl₂-PEO electrolyte has a MgCl₂·6H₂O:PEO (MW=2,000,000): H₂O mass ratio of 4:1:1.

To ensure uniformity, the mixture was magnetically stirred under a hot water bath at 60° C. overnight. After cooling down to room temperature, the resulting solid-state electrolyte was pressed into 2 mm-thick films for use. A prototype of a single cell was assembled so as to have a layered structure, where the solid-state electrolyte was inserted between a pure Mg foil and a carbon paper substrate coated with CuHCF ink. Each electrode was connected to a piece of silver foil which acts as the current collector (FIG. 1B). The prototype was housed in poly(methyl methacrylate) (PMMA) cells, as shown in the inset photo of FIG. 1B.

While FIG. 1B shows a single cell, practical battery pack systems with multiple stacked cells can be created from the single cell for different applications.

The battery performance was evaluated at various current densities ranging from 0.25 to 5 A g⁻¹ (FIG. 1C). It exhibits a remarkable discharge voltage plateau of 2.6-2.0 V and a discharge capacity of 120 mAh g⁻¹ at 0.25 A g⁻¹. Lower discharge voltages are displayed at higher specific currents, but the battery can still support a voltage plateau of 2.4-1.9 V and a discharge capacity of 100 mAh g⁻¹ at a current rate as high as 5 A g⁻¹. A Coulombic efficiency of up to 95% can be achieved at 0.25 A g⁻¹ (FIG. 1D). The battery also demonstrates impressive long-term cyclic stability, with a capacity retention rate of 88% after 900 cycles at 1 A g⁻¹ (FIG. 1E). To enable practical applications in the future, a battery pack will be assembled with multiple cells to achieve higher voltage outputs.

FIG. 1F shows a performance comparison of the present invention with other Mg batteries reported in the literature, including non-aqueous Mg metal batteries (NAMMB) and aqueous Mg-ion batteries (AMIB). Impressively, the battery cell of the present invention demonstrates one of the highest performances, clearly exhibiting a superior voltage output and energy density compared to other reported Mg batteries.

Non-aqueous Mg metal batteries (NAMMB) are disclosed in articles [1-5] and aqueous Mg-ion batteries (AMIB) are disclosed in articles [6-10]. The discharge capacities and energy densities of AMMB and NAMMB in FIG. 1F are reported per mass of active material at the cathode. Discharge capacities and energy densities of AMIB are reported per total mass of active material at both the anode and cathode. Average discharge voltage and capacity are shown for PPMDA: poly pyromellitic dianhydride; LVP: lithium vanadium phosphate; PI: polyimide; NiHCF: nickel hexacyanoferrate; OMS: octahedral molecular sieves; PTCDI: 3,4,9,10-perylene-tetracarboxylic acid diimide; CMS: carbon molecular sieves; NP: naphthalene-hydrazine diimide polymer; P (NDI2OD-T2): poly [N,N′-bis(2-octyldodecyl)-1,4,5,8-naphthalenedicarboximide-2,6-diyl]-alt-5,5′-(2,2′-bithiophene); and HMDS: hexamethyldisilazide; 14PAQ: 1,4-polyanthraquinone are illustrated in FIG. 1F.

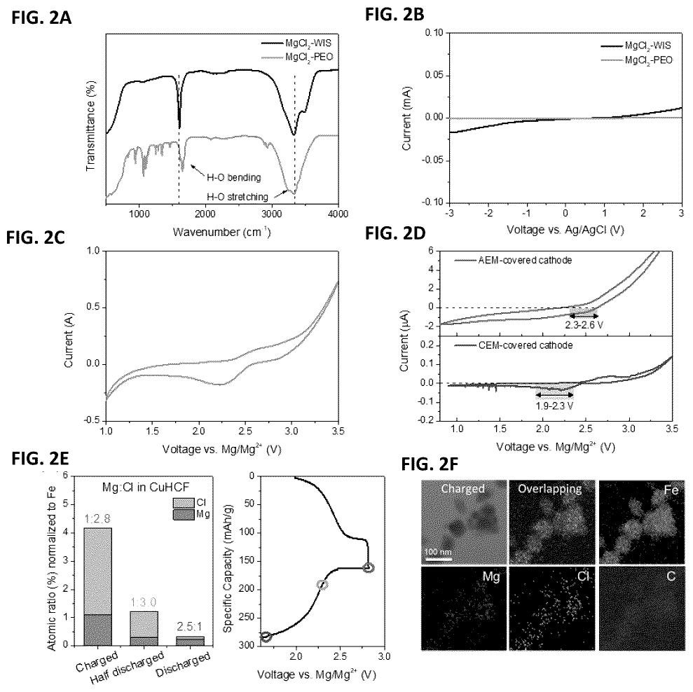

The MgCl₂-PEO electrolyte plays a primary role in producing this high-voltage, stable, aqueous solid-state Mg battery. When PEO is present, H—O bonds between the polymer backbone and water molecules in the electrolyte tend to form because of the higher negative charge density of the oxygen atom in PEO, due to the inductive effect of alkyl groups [11]. As a result, PEO acts as a hydrogen bond anchor that suppresses water decomposition and widens the electrochemical stability window of the electrolyte, enabling a high battery voltage. This is confirmed by Fourier-transform infrared spectroscopy (FTIR) analysis of MgCl₂-PEO, compared with a MgCl₂ water-in-salt (WIS) electrolyte without PEO addition. MgCl₂-WIS exhibits two major peaks at 1608 and 3330 cm⁻¹, which represent the bending and stretching vibrations of H—O bonds of water respectively (FIG. 2A). In contrast, the peaks shift to higher wavenumbers of 1656 and 3339 cm⁻¹ and the intensities are reduced in MgCl₂-PEO, which illustrates the reinforcement of the H—O bond due to PEO-H2O coordination and the reorganization of the proton donor framework [11]. As a result, the introduction of PEO strongly inhibits water decomposition and expands the electrochemical stability window of the electrolyte, as shown in FIG. 2B, where the onset of hydrogen evolution reaction (HER) and oxygen evolution reaction (OER) in MgCl₂-PEO become undetectable between −2.0 V to 2.0 V vs. Ag/AgCl.

The wide electrochemical stability window of the solid-state electrolyte allows the system to take full advantage of the highly negative reduction voltage of the Mg anode, while enabling high-voltage ion (de-)intercalation processes at the cathode. A cyclic voltammetry (CV) scan of the Mg/CuHCF full battery reveals a broad reduction peak centered at around 2.35 V vs. Mg/Mg²⁺ (FIG. 2C), which matches the high discharge voltage plateau from the battery cycling curves in FIG. 1C.

To identify the types of intercalated ions, half-cell CV scans were performed on CuHCF cathodes covered with ion exchange membranes (FIG. 2D). Using an anion exchange membrane (AEM) covered cathode, a high reduction peak of 2.3-2.6 V vs. Mg/Mg²⁺ can be observed. Using a cation exchange membrane (CEM) covered cathode, a lower reduction peak of 1.9-2.3 V vs. Mg/Mg²⁺ is found. Evidently, the battery undergoes a high-voltage extraction of anion species, followed by a cation insertion mechanism during discharge. Due to the expanded electrochemical stability window of the PEO-based electrolyte, the promoted anion (de-) intercalation voltage can be achieved, compared with previous aqueous Mg batteries.

The dual ion species are identified using energy dispersive X-ray spectroscopy (EDS) analyses of CuHCF at different states of charge (FIG. 2E). When fully charged, the Mg: Cl atomic ratio in CuHCF is 1:2.8, which demonstrates the storage of [MgCl₃], which is within the experimental error. TEM mapping, where the intensity and color represents the concentration of a particular element, provides visual evidence of both Mg and Cl in the cathode material after charging (FIG. 2F). When subsequently discharged to 2.3V, the Mg and Cl content in CuHCF dropped significantly, yet traces of [MgCl₃] can still be detected as the Mg: Cl atomic ratio remains 1:3.0. However, after full discharge to 1.6V, the Mg content surpasses Cl with an atomic ratio of 2.5:1. Thus, the most plausible process is a dual-ion reaction mechanism where [MgCl₃] inserts into the CuHCF lattice during battery charging and extracts during high-voltage discharge, followed by the insertion of Mg²⁺ during subsequent discharge. The dual-ion reaction mechanism at the cathode and the reversible stripping/plating of the Mg anode are the main factors contributing to the high voltage and capacity of the battery.

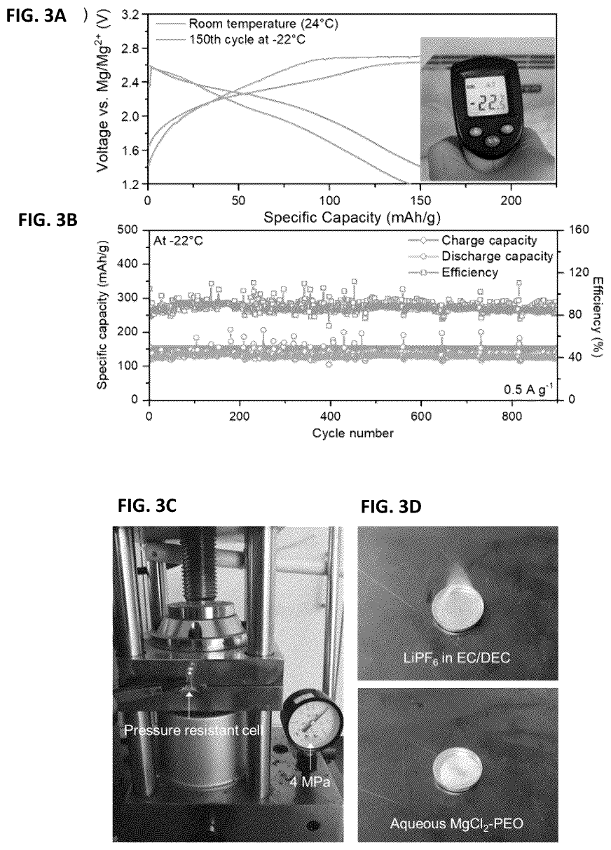

FIG. 3A to FIG. 3D show Low-temperature, pressure, and flammability tests of the Quasi-solid-state magnesium battery (QSMB), which tests confirm environmental tolerance of the MgCl₂-PEO battery.

The magnesium battery exhibits remarkable endurance in harsh operating conditions such as sub-zero temperatures, high pressure, and fire. In contrast to traditional Li-ion batteries, which suffer from reduced power output and permanent damage in freezing temperatures, the QSMB performs equally well at −22° C. compared to room temperature, with no performance degradation after 900 cycles, or 25 days of cycling, at 0.5 A g−1 (as shown in FIG. 3A and FIG. 3B). This is due to the hydrogen bond anchoring effect of PEO, which effectively lowers the freezing temperature in the aqueous electrolyte (1), thereby maintaining ionic conduction and sustaining high performance. Additionally, the QSMB is highly resistant to high pressure loading and can light up an LED at 4 MPa, as demonstrated in the setup of FIG. 3C. Furthermore, the aqueous quasi-solid-state electrolyte is fire-resistant, making it a safer alternative to the organic electrolytes used in conventional Li-ion batteries. Upon contact with an ignited cotton swab, commercial LiPF6 in ethylene carbonate (EC)/diethyl carbonate (DEC) instantly catches fire, while MgCl2-PEO extinguishes the fire (FIG. 3D). These anti-freezing, pressure-resistant, and non-flammable properties of the present invention form a strong basis for a practical, robust, and safe battery technology that could facilitate a wide range of commercial applications in the future.

### REFERENCES

The cited references in this application are incorporated herein by reference in their entirety and are as follows:
[1] Liu, F., Liu, Y., Zhao, X., Liu, X., and Fan, L.-Z. Pursuit of a high-capacity and long-life Mg-storage cathode by tailoring sandwich-structured MXene@ carbon nanosphere composites. J. Mater. Chem. A 2019, 7 (28), 16712-16719.
[2] Son, S.-B., Gao, T., Harvey, S. P., Steirer, K. X., Stokes, A., Norman, A., Wang, C., Cresce, A., Xu, K., and Ban, C. An artificial interphase enables reversible magnesium chemistry in carbonate electrolytes. Nat. Chem. 2018, 10 (5), 532-539.
[3] Dong, H., Liang, Y., Tutusaus, O., Mohtadi, R., Zhang, Y., Hao, F., and Yao, Y. Directing Mg-storage chemistry in organic polymers toward high-energy Mg batteries. Joule 2019, 3 (3), 782-793.
[4] Pan, B., Huang, J., Feng, Z., Zeng, L., He, M., Zhang, L., Vaughey, J. T., Bedzyk, M. J., Fenter, P., and Zhang, Z. Polyanthraquinone-Based Organic Cathode for High-Performance Rechargeable Magnesium-Ion Batteries. Advanced Energy Materials 2016, 6 (14), 1600140.
[5] Bančič, T., Bitenc, J., Pirnat, K., Lautar, A. K., Grdadolnik, J., Vitanova, A. R., and Dominko, R. Electrochemical performance and redox mechanism of naphthalene-hydrazine diimide polymer as a cathode in magnesium battery. J. Power Sources 2018, 395, 25-30.
[6] Zhang, Z., Li, Y., Zhao, G., Zhu, L., Sun, Y., Besenbacher, F., and Yu, M. Rechargeable Mg-Ion Full Battery System with High Capacity and High Rate. ACS Applied Materials & Interfaces 2021, 13 (34), 40451-40459.
[7] Zhang, H., Cao, D., and Bai, X. High rate performance of aqueous magnesium-ion batteries based on the 8-Mn02@ carbon molecular sieves composite as the cathode and nanowire VO2 as the anode. Journal of Power Sources 2019, 444, 227299.
[8] Wang, F., Fan, X., Gao, T., Sun, W., Ma, Z., Yang, C., Han, F., Xu, K., and Wang, C. High-voltage aqueous magnesium ion batteries. ACS Central Sci. 2017, 3 (10), 1121-1128.
[9] Chen, L., Bao, J., Dong, X., Truhlar, D., Wang, Y., Wang, C., and Xia, Y. Aqueous Mg-ion battery based on polyimide anode and Prussian blue cathode. ACS Energy Lett. 2017, 2 (5), 1115-1121.
[10] Zhang, H., Ye, K., Zhu, K., Cang, R., Yan, J., Cheng, K., Wang, G., and Cao, D. High-Energy-Density Aqueous Magnesium-Ion Battery Based on a Carbon-Coated FeVO4 Anode and a Mg-OMS-1 Cathode. Chem. Eur. J. 2017, 23 (67), 17118-17126.
[11] Fu, Q., Wu, X., Luo, X., Indris, S., Sarapulova, A., Bauer, M., Wang, Z., Knapp, M., Ehrenberg, H., and Wei, Y. High-Voltage Aqueous Mg-Ion Batteries Enabled by Solvation Structure Reorganization. Advanced Functional Materials 2022, 2110674.
[10] S. Liu et al., From room temperature to harsh temperature applications: Fundamentals and perspectives on electrolytes in zinc metal batteries. Sci. Adv. 8, eabn5097 (2022).

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A rechargeable aqueous Mg battery comprising:
a Mg metal anode,
a solid-state aqueous polymer-based electrolyte, and
an intercalation-type Prussian blue analogue cathode for ion storage in the form of a cubic lattice structure.

2. The rechargeable aqueous Mg battery of claim 1 wherein the solid-state aqueous polymer-based electrolyte is a solid-state MgCl₂-polyethylene oxide (PEO) electrolyte.

3. The rechargeable aqueous Mg battery of claim 2 wherein the the MgCl₂-PEO electrolyte has a MgCl₂·6H₂O:PEO (MW=2,000,000):H₂O mass ratio of 4:1:1

4. A method of forming a rechargeable aqueous Mg battery comprising the steps of:
providing a Mg anode,
providing a solid-state aqueous polymer-based electrolyte, and
providing an intercalation-type Prussian blue analogue cathode for ion storage in the form of a cubic lattice structure,
mixing components of the electrolyte by magnetic stirring under a hot water bath at about 60° C. overnight,
cooling the mixture to room temperature,
pressing the resulting solid-state electrolyte into approximately 2 mm-thick films for use,
assembling a single cell as a layered structure, where the solid-state electrolyte is inserted between a pure Mg foil and a carbon paper substrate coated with CuHCF ink,
connecting an electrode to a piece of silver foil which acts as the current collector, and
housing the cell in a poly(methyl methacrylate) (PMMA) cell.

5. The method of claim 4 wherein the solid-state aqueous polymer-based electrolyte is a solid-state MgCl₂-polyethylene oxide (PEO) electrolyte.

6. The method of claim 4 wherein the Prussian blue cathode is an analogue of copper hexacyanoferrate (CuHCF) with a chemical formula of Cu2[Fe(CN)6], said cathode providing storage sites for ion insertion and extraction in the form of a cubic lattice structure.

7. The method of claim 4 wherein single cells are combined into multiple cells to increase voltage and/or capacity.
